(19) United States
(12) Patent Application Publication
(10) Pub. No.: US 2021/0326662 A1
(43) Pub. Date: Oct. 21, 2021

(54) ENVIRONMENT MODELING AND ABSTRACTION OF NETWORK STATES FOR COGNITIVE FUNCTIONS

(71) Applicant: Nokia Technologies Oy, Espoo (FI)

(72) Inventors: Stephen MWANJE, Dorfen (DE); Benedek SCHULTZ, Budapest (HU); Marton KAJO, Munich (DE)

(21) Appl. No.: 17/258,924

(22) PCT Filed: Jul. 19, 2018
(86) PCT No.: PCT/EP2018/069638

§ 371 Date: Jan. 8, 2021

(51) Int. Cl. G06K 9/62; G06N 3/04; G06N 3/08

(52) U.S. Cl. CPC G06K 9/6269; G06N 3/08; G06N 3/0454; G06K 9/6223

(57) ABSTRACT

An EMA method of enabling CNM in communication networks comprises, for a given time instant t, extracting (S601) features from an n-dimensional input vector X^{t} containing at least one of continuous valued environmental parameters, network configuration values and key performance indicator values, and forming a d-dimensional feature vector Y^{t} from the extracted features, quantizing (S602) the formed feature vector Y^{t} by selecting, for the extracted vector Y^{t}, a single quantum corresponding to an internal state of k internal states of an internal state-space model, mapping (S603), for each dimension Sₘ of an m-dimensional output vector S^{t}, an output state bin of a number of output state bins present for dimension Sₘ to the selected internal state, and, for each cognitive function off cognitive functions, selecting (S604) a subset out of the output vector S^{t}, each of the subsets having a dimension equal to or smaller than m and containing feature values required by the cognitive function, the f selected subsets being different in dimension from each other.

### TECHNICAL FIELD

Some embodiments relate to environment modeling and abstraction of network states for cognitive functions. In particular, some embodiments relate to Cognitive Network Management (CNM) in 5G (radio access) networks and other (future) generations of wireless/mobile networks.

### BACKGROUND

The concept of CNM has been advanced in several publications [1, 2, 3], which propose to replace SON functions with Cognitive Functions (CFs) that learn optimal behavior based on their actions on the network, the observed or measured impact thereof, and using various kinds of data, e.g., network planning, configuration, performance and quality, failure, or user/service-related data.

### CITATION LIST

[1] S. Mwanje et al., “Network Management Automation in 5G: Challenges and Opportunities,” in Proc. of the 27th IEEE International Symposium on Personal, Indoor and Mobile Radio Communications (PIMRC), Valenica, Spain, Sep. 4-7, 2016
[2] Stephen S Mwanje, Lars Christoph Schmelz, Andreas Mitschele-Thiel, “Cognitive Cellular Networks: A Q-Learning Framework for Self-Organizing Networks”, IEEE Transactions on Network and Service Management, Vol 13, Issue 1, Pages 85-98, 2016/3
[3] PCT/IB2016/055288, “Method and Apparatus for Providing Cognitive Functions and Facilitating management in Cognitive Network Management Systems” filed Sep. 2, 2016
[4] FastICA online at http://research.ics.aalto.fi/ica/fastica/
[5] A. Hyvarinen. “Fast and robust fixed-point algorithms for independent component analysis”, IEEE Trans. on Neural Networks, 10(3):626-634, 1999.
[6] T. Kohonen, M. R. Schroeder, and T. S. Huang (Eds.). Self-Organizing Maps (3rd ed.). Springer-Verlag New York, Inc., Secaucus, N.J., USA. 2001.
[7] Makhzani, Alireza and Brendan J. Frey. “k-Sparse Autoencoders.” CoRR abs/1312.5663 (2013): n. pag.
[8] Sepp Hochreiter and Jürgen Schmidhuber. 1997. Long Short-Term Memory. Neural Comput. 9, 8 (November 1997), 1735-1780.
[9] Melanie Mitchell. 1998. An Introduction to Genetic Algorithms. MIT Press, Cambridge, Mass., USA.
[10] Márton Kajó, Benedek Schultz, Janne Ali-Tolppa, Georg Carle, “Equal-Volume Quantization of Mobile Network Data Using Bounding Spheres and Boxes”, IEEE/IFIP Network Operations and Management Symposium, Taipei, Taiwan April 2018

### LIST OF ABBREVIATIONS

5G Fifth Generation
CE Coordination Engine
CF Cognitive Function
CME Configuration Management Engine
CNM Cognitive Network Management
DAE Decision Action Engine
EMA Environment Modeling & Abstraction
KPI Key Performance Indicator
NCP Network Configuration Parameter
NM Network Management
OAM Operations, Administration and Management
SON Self-Organizing Networks

### SUMMARY

With the success of Self Organizing Networks (SON), but also its shortcomings in terms of flexibility and adaptability to changing and complex environments, there is a strong demand for more intelligent Operations, Administration and Management (OAM) functions to be added to the networks. The objective of CNM is thereby that OAM functions should be able to 1) learn the environment they are operating in, 2) learn their optimal behavior fitting to the specific environment, 3) learn from their experiences and that of other instances of the same or different OAM functions, and 4) learn to achieve the higher-level goals and objectives as defined by the network operator. This learning shall be based on one or more or all kinds of data available in the network (including, for example, performance information, failures, configuration data, network planning data, or user and service related data) as well as from the actions and the corresponding impact of the OAM function itself. The learning and the knowledge built from the learned information shall thereby increase the autonomy of the OAM functions.

In effect, CNM extends SON to: 1) infer higher level network and environment states from a multitude of data sources instead of the current low-level basic states recovered from KPI values 2) allow for adaptive selection and changes of NCPs (Network Configuration Parameters) depending on previous actions and operator goals. The first objective (modeling of states) is critical to the operation of CNM since CFs are expected to respond to specific states of the network. So CNM needs a module that abstracts the observed KPIs into states to which the CFs respond. Moreover, the abstraction must be consistent across multiple CFs in one or more network elements, domains or even subnetworks. And even within a single CNM instance, multiple modules need to work together (e.g. a configuration engine and a coordination engine) for the system to eventually learn the optimal network configurations. These modules should or must reference similar or the same abstract states in coordinating their responses and so they (may) require a separate module that defines these states. Meanwhile, the creation of such states should be flexible enough to allow for their online adjustment during operations, i.e., the EMA should be able to modify/split/aggregate/delete states as may be required by the subsequent entities.

Part of the learning processing is describing network states in a way that different functions have a common view of the network and that actions from different functions can be compared, correlated and coordinated. The respective function may in general terms be described as modeling and abstraction of network environment states in a way that is understandable to the different Cognitive Functions (CFs).

Some embodiments relate to the design of CFs and systems, and specifically focus on the design and realization of the Environment Modeling & Abstraction (EMA) module of a CF/CNM system.

According to some example embodiments, an EMA apparatus, a method and a non-transitory computer-readable medium are provided, that enable CNM in communication networks.

In the following the invention will be described by way of embodiments thereof with reference to the accompanying drawings.

### BRIEF DESCRIPTION OF THE DRAWINGS

FIG. 1 shows a schematic diagram illustrating a CF framework including an EMA module within a CNM system.

FIG. 2 shows a schematic diagram illustrating components and input-output states of an EMA module according to some embodiments.

FIG. 3 shows a schematic diagram illustrating logical functions of the EMA module in environment modeling according to some embodiments.

FIG. 4 shows a schematic diagram illustrating an internal state-space representation of a network state.

FIG. 5 shows a schematic diagram illustrating logical functions of the EMA module in state abstraction according to some embodiments.

FIG. 6 shows a flowchart illustrating an EMA process according to an example embodiment.

FIG. 7 shows a schematic block diagram illustrating a configuration of a control unit in which examples of embodiments are implementable.

FIG. 8 shows a schematic diagram illustrating an encoder-decoder process of an Autoencoder according to an example implementation.

FIG. 9 shows schematic diagrams illustrating SOMs fitted on different distributions according to an example implementation.

FIG. 10 shows a schematic diagram illustrating mapping of an output state to the internal state-space according to an example implementation.

### DESCRIPTION OF THE EMBODIMENTS

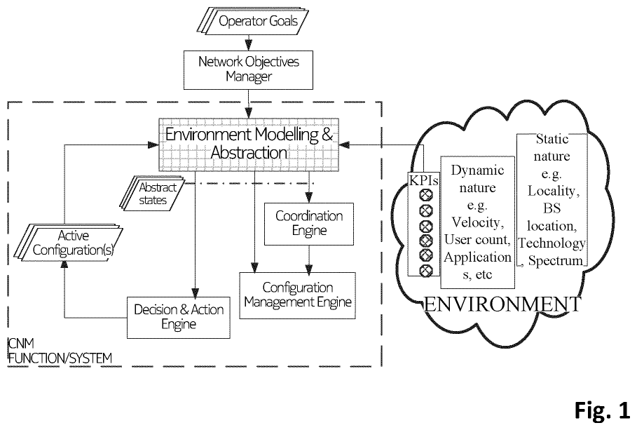

FIG. 1 shows a schematic diagram illustrating a CF framework including an EMA module within a CNM system.

The CF framework comprises five major components shown in FIG. 1, which carry the functionality required by a CF to learn and improve from previous actions, as well as to learn and interpret its environment and the operator's goals.

The respective components are:
a Network Objectives Manager (NOM) which interprets operator service and application goals for CNM or for the specific CF to ensure that the CF adjusts its behavior in line with those goals;
an Environment Modeling & Abstraction (EMA) module which learns to abstract the environment into states which are used for subsequent decision making in the other components;
a Configuration Management Engine (CME) which defines, learns and refines the permissible candidate network configurations for the different contexts of the CF;
a Decision & Action Engine (DAE) which learns and matches the current abstract state as derived by the EMA module to the appropriate network configuration (i.e. ‘active configuration’) selected from the set of legal/acceptable candidate network configurations; and
a Coordination Engine (CE) which needs to coordinate the actions and recommendations of multiple DAEs or CFs, even amidst the non-deterministic behavior of the DAEs or CFs resulting from their learning nature.

In citation [3], the expected functionality of the EMA module and its deliverable to the other sub-functions are specified, i.e. to
define the abstract states built, for example, from different combinations of quantitative KPIs, abstract (semantic) state labels, and operational contexts, e.g., current network or network element configurations; and
create new or change (modify, split, delete, etc.) existing quantitative or abstract external states as and when needed by the other CF sub-functions
the CME, DAE & CE in learning the effects of different configurations in different environment states.

Some embodiments to be described in the following focus on defining an EMA module explicitly.

In example embodiments described more fully hereinafter with reference to the accompanying drawings, in which some, but not all embodiments are shown, the terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

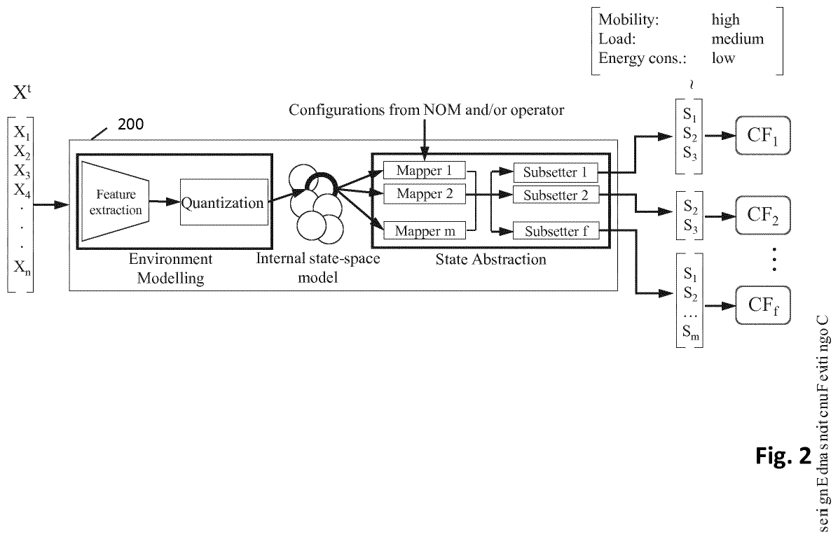

Referring to FIG. 2, according to some embodiments, an EMA module 200 is made up of 4 distinct components that together achieve the global tasks of modeling and abstraction. Each of the two tasks/phases (i.e. environment modeling and state abstraction) of the EMA module 200 involves 2 internal steps with the two phases connected through an EMA-internal model of the state-space as illustrated in FIG. 2. Environment modeling involves feature extraction and quantization to generate an equivalent internal state for a given input. Then, state abstraction undertakes mapping to generate the full output state vector and sub-setting the state vector to select the dimensions of interest for one or more or each CF.

EMA Input-Output System

As illustrated in FIG. 2, according to some embodiments, an input to the EMA module 200 at a given time instant t is a vector X^{t}=[X₁^{t}, X₂^{t}, . . . , Xₙ^{t}]^{T} of continuous valued environmental parameters, network configuration values and KPI values Xₙ. The EMA module 200 filters this vector to generate the required output.

An output of the EMA module 200 is a set of CF-feature vectors S each of dimension equal to or smaller than m (m being the number of output states) and each of which contains the output states that are of interest to a specific cognitive function or engine. Each CF-feature vector S is a subset of the big network-state-vector and contains different combinations of feature values e.g. appropriate for the specific CF. The network-state vector (of dimension m) contains the states of the network along the number of prescribed (quasi-orthogonal) dimensions of interest/optimization. Such dimensions may for example be those for which the operator expects some action to be taken e.g. user mobility, cell load, energy consumption level, etc. They will be defined either by the operator or by the Network Objectives Manager through the configuration of the EMA module.

EMA Processing Steps—Environment Modeling

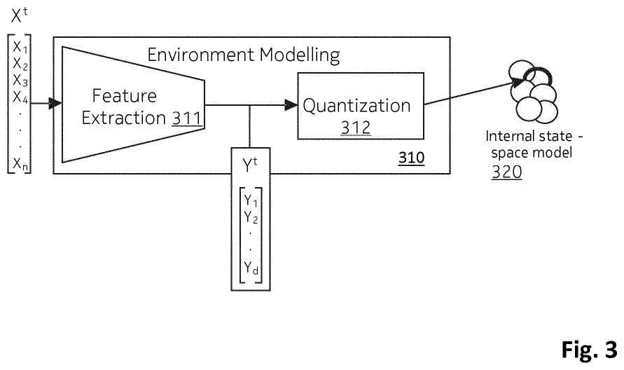

Referring to FIG. 3, according to some embodiments, a function of an environment modeling block 310 of the EMA module 200 is to map an incoming input vectors X (with X=[X₁, X₂, . . . , Xₙ]^{T}) of a plurality of vectors X of continuous valued environmental parameters, network configuration values and KPI values Xₙ to one of k internal states on internal state-space model 320 of the EMA module 200 at runtime.

At training time, the environment modeling block 310 also needs to form these internal states. This equates to transforming the n-dimensional continuous-space input into k discrete segments, through quantization. Since it can be expected that some of the input dimensions contain noise or redundant information, it is beneficial to precede the quantization step with a feature extractor, which removes these interfering parts of the data. Following this logic, according to some embodiments, the environment modeling is split into two logical functions of feature extraction in a feature extraction block 311 and quantization in a quantization block 312, which form the first two EMA steps shown in FIG. 3.

In particular, according to some embodiments, in a first step, in feature extraction block 31 of environment modeling block 310, feature extraction is performed. For each time instant, the feature extraction block 311 compresses the input information X^{t} to a lower-dimensional representation Y^{t}=[Y₁^{t}, Y₂^{t}, . . . , Y_{d}^{t}]^{T}, while also removing redundant information and noise from the input X^{t}. According to some example implementations, this involves tasks such as combining different parameters with similar or the same underlying measure/metric (e.g. handover margins, time to trigger and cell offsets) into a single dimension (in this case handover delay). The number d of extracted features is usually much smaller than the number of input features (d<<n), but using more dimensions (d>>n) with sparsity enforced is also a viable alternative.

In a second step, in quantization block 312 of environment modeling block 310, quantization is performed. The quantization block 312 selects a single quantum from the internal state-space model 320 that best represents the current network state at the inference stage, and builds the quantization at training.

EMA Processing Steps—State Abstraction

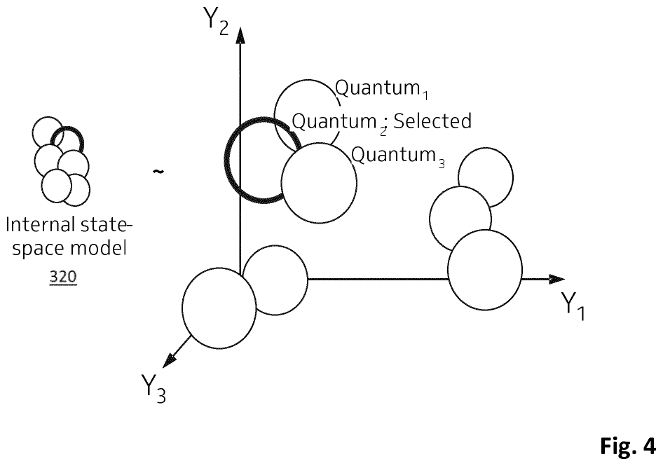

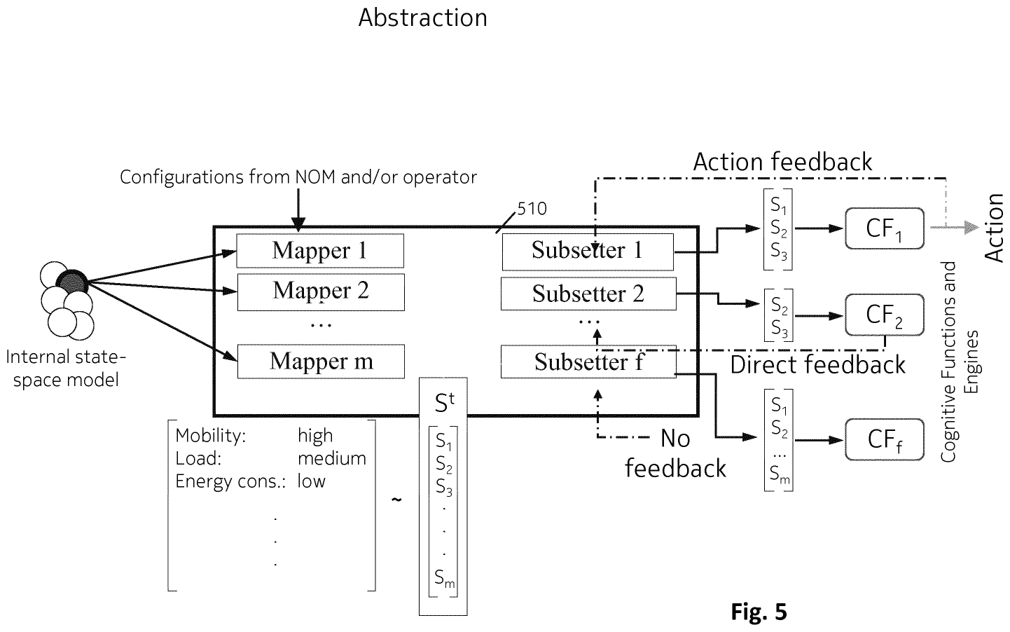

According to some embodiments, a function of a state abstraction block of the EMA module 200 is to translate the internal state selected by the environment modeling block 310 to a representation that is useful for the CFs. The internal state-space model 320, illustrated in FIG. 4, is not modifiable after training, and tries to encompass one or more or all behavioral aspects of the network elements. A state abstraction block 510 shown in FIG. 5 has the task of creating a flexible mapping which can be modified during runtime to fit the CFs' need. In other words, it bridges the gap between the global internal representation and a CF specific representation. This allows more flexible and dynamic state space mapping, as well as enabling feedback from the cognitive functions to get a better representation for the specific functions. According to some example implementations, the two requirements are realized in two components forming the third and fourth steps of the EMA, which are shown in FIG. 5.

In a third step, state mapping is performed by the state abstraction block 510. In the state mapping, the previously selected internal state is assigned to bins for each dimension Sₘ of S^{t}=[S₁^{t}, S₂^{t}, . . . , Sₘ^{t}]^{T} of the output network-states. This mapping is unique for each dimension Sₘ, realized by a separate mapper for this dimension. According to some embodiments, mapping parameters, such as the binning, is influenced/configured by the NOM or the operator according to their global objectives.

In a fourth step, subsetting is performed by the state abstraction block 510. In subsetting, different subsets of the full network-state vector are selected to support (only) the necessary information that is required by the corresponding cognitive functions. This is done by individual subsetter elements (Subsetter₁, Subsetter₂, . . . , Subsetter_{f}) unique to the specific CF of plurality of CFs comprising CF₁, CF₂, . . . , CF_{f}. The subsetting can be influenced in multiple ways, as explained later on. A default subsetter (Subsetter_{f} in FIG. 5) that is an identity function is also included to output the full network state.

According to some embodiments, since the state abstraction can be influenced by reconfigurations of the constraints for the specific dimensions, the EMA module 200 needs to have a finely-grained internal representation of the state-space which it uses to abstract into the output states. Thereby, even with reconfiguration of constraints, it does not need to re-learn the underlying state-space model, but only adjusts the mapping between internal and external (output) states and subsets.

It is to be noted that the above-mentioned variables n, d, k, m and f are positive integers.

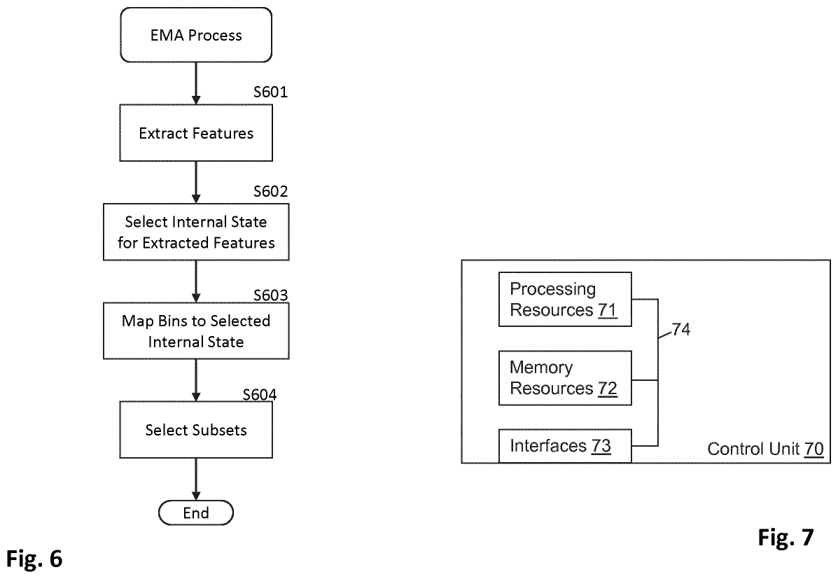

Now reference is made to FIG. 6 which shows a flowchart illustrating an EMA process according to an example embodiment.

The EMA process of FIG. 6 which enables CNM in communication networks, e.g. radio access networks, may be performed by an EMA apparatus. According to an example implementation, the EMA apparatus comprises the EMA module 200.

In step S601 of FIG. 6, for a given time instant t, features are extracted from an n-dimensional input vector X^{t} containing at least one of continuous valued environmental parameters, network configuration values and key performance indicator values, and a d-dimensional feature vector Y^{t} is formed from the extracted features. According to some embodiments, step S601 corresponds to the above-described first step the function of which is illustrated in FIG. 3.

In step S602 of FIG. 6, the formed feature vector Y^{t} is quantized by selecting, for the extracted vector Y^{t}, a single quantum corresponding to an internal state of k internal states of an internal state-space model. According to some embodiments, step S603 corresponds to the above-described second step the function of which is illustrated in FIG. 3.

In step S603 of FIG. 6, for each dimension Sₘ of an m-dimensional output vector S^{t}, an output state bin of a number of output state bins present for dimension Sₘ is mapped to the selected internal state. According to some embodiments, step S603 corresponds to the above-described third step the function of which is illustrated in FIG. 5.

In step S604, for each cognitive function of f cognitive functions, a subset is selected out of the output vector S^{t}, each of the subsets having a dimension equal to or smaller than m and containing feature values required by the cognitive function, the f selected subsets being different in dimension from each other. According to some embodiments, step S604 corresponds to the above-described fourth step the function of which is illustrated in FIG. 5.

Now reference is made to FIG. 7 for illustrating a simplified block diagram of an electronic device suitable for use in practicing exemplary embodiments. FIG. 7 illustrates a configuration of a control unit 70 that is operable to execute the process shown in FIG. 6, for example. According to an example implementation, the control unit 70 is part of and/or is used by the EMA module 200.

The control unit 70 comprises processing resources (processing circuitry) 71, memory resources (memory circuitry) 72 and interfaces (interface circuitry) 73, coupled by a connection 74.

As used in this application, the term “circuitry” may refer to one or more or all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

The memory resources (memory circuitry) 72 store a program assumed to include program instructions that, when executed by the processing resources (processing circuitry) 71 enable the control unit 70 to operate in accordance with exemplary embodiments, as detailed herein.

The memory resources (memory circuitry) 72 may be of any type suitable to the local technical environment and may be implemented using any suitable data storage technology, such as semiconductor based memory devices, magnetic memory devices and systems, optical memory devices and systems, fixed memory and removable memory comprising a non-transitory computer-readable medium. The processing resources (processing circuitry) 71 may be of any type suitable to the local technical environment, and may include one or more of general purpose computers, special purpose computers, microprocessors, digital signal processors (DSPs) and processors based on a multi core processor architecture, as non limiting examples.

Training and Utility

The EMA module 200 needs to be trained before it is used as desired. The above-described first to third steps can be trained from observations of the network in different states while the fourth step requires feedback from actual CFs to train the sub-setters to learn the respective subsets. Although it is tempting to consider manually designing and constructing a mapping function that accomplishes the first to third steps, i.e., mapping each observation in continuous space to a vector of discrete values on quasi-orthogonal dimensions, it is not an obvious activity. Correspondingly, a training process is needed to ensure that the EMA module 200 learns the best matching function as described in more detail below.

A critical part of the EMA module 200 is the realization of the internal state representation as created by the environment modeling block 310. This is then the input to the state abstraction block 510 to create a CF specific output that well represents the network conditions at the time, both in general and with respect to the needs of the specific CF.

For the internal state-space model 320 to map the network's behavior regardless of user bias, environment modeling functions need to be trainable in an unsupervised manner, without labelled training data. Usually, most of the unsupervised learning algorithms do require a handful of meta-parameters, which must be set prior to training by the user, or, by the implementer. The environment modeling (EM) steps will not be reconfigurable after training, and should be trained with as much data as possible from the network to be able to form a comprehensive mapping that can be applied to one or more or all network elements and CFs.

The state abstraction (SA) functions need to be trained in a supervised or semi-supervised way owing mainly to the need for feedback from the CFs about the utility of the different dimensions for the CFs.

Multiple implementation options are foreseen for each of the four components, which will be described in the following. One of differentiators between the implementation options is whether the two logical functions in each phase (modeling or abstraction) are realized as separate steps, or can be incorporated into a single learning stage.

Feature Extraction Using Independent Component Analysis

According to an example implementation, in step S601 of FIG. 6, during training (and at runtime) of the EMA module 200, the features are extracted from the input vector X^{t} using an independent component analysis.

Independent Component Analysis (ICA) is a statistical technique for finding hidden factors that underlie sets of random variables. The data variables are assumed to be linear mixtures of some unknown latent, non-Gaussian and mutually independent variables mixed with an unknown mixing mechanism: i.e., X=AS, where S is the latent vector.

Pre-processing: The most basic and necessary pre-processing is to centre S, i.e. subtract its mean vector m=E{X} to make X a zero-mean variable. After estimating the mixing matrix A with centered data, the estimation can be completed by adding the mean vector of S back to the centered estimates of Sₘ The mean vector of S is given by A⁻¹m, where m is the mean vector that was subtracted in the pre-processing.

A first step in many ICA algorithms is to whiten the data by removing any correlations in the data. After whitening, the separated signals can be found by an orthogonal transformation of the whitened signals y as a rotation of the joint density. There are many algorithms for performing ICA and one very efficient one is the FastICA (fixed-point) algorithm described in citation [4], which finds directions with weight vectors W₁, . . . Wₙ, such that for each vector Wᵢ, the projection Wᵢ^{T}X maximizes non-Gaussianity. Thereby, the variance of Wᵢ^{T}X must here be constrained to unity which for whitened data is equivalent to constraining the norm of W to be unity.

The FastICA is based on a fixed-point iteration scheme for finding a maximum of the non-Gaussianity of Wᵢ^{T}X which can be derived as an approximative Newton iteration. This can be computed using an activation function g and its derivative g′ e.g. g(u)=tanh(au) and g′(u)=u exp(−u²/2), where 1≤a≤2 is some suitable constant, often as a=1.

The basic form of the FastICA algorithm is as shown below. To prevent different vectors from converging to the same maxima the outputs W₁^{T}X, . . . , Wₙ^{T}X have to be decorrelated after every iteration (see citation [5]) which is indicated below at step 4.

FastICA Algorithm:
1. Choose an initial (e.g. random) weight matrix W.

Repeat until convergence:
2. Let W+=E{X g(W^{T}X)}−E{g′(W^{T}X)}W
3. Let W=W+/∥W+∥ where ∥.∥ is the norm e.g. the second norm
4. a) Let W=W/√∥WW^{T}∥
   Repeat until convergence
   b) Let W=1.5 W−0.5 WW^{T}W

Feature Extraction Using Autoencoders

According to another example implementation, in step S601 of FIG. 6, during training (and at runtime) of the EMA module 200, the features are extracted from the input vector X^{t} using autoencoders.

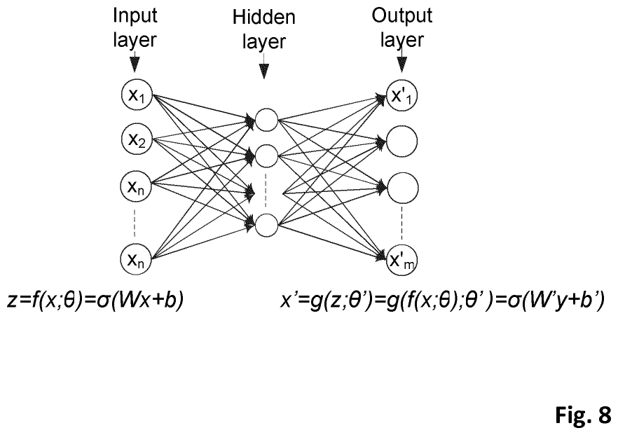

An autoencoder is an unsupervised neural network used for learning efficient encodings of a given data set. For a dataset X, the autoencoder encodes X with a function θ to an intermediate representation Z and decodes Z to X′, the estimate of X through a mapping function θ′. This is represented by FIG. 8, where the intermediate representation Z is the set of extracted noise-free features that are desired to be learned.

The dimension, m, of the intermediate representation depends on (and is equivalent to) the size of the hidden layer, and can be of a lower or higher dimensionality than that of the input/output layers. The autoencoder learns the encoding and decoding functions θ, θ′ by minimizing the difference between X and X′ using a specific criterion—usually the mean squared error or cross entropy loss. After training, this hidden layer encoding is utilized to compress the information, removing unnecessary and noisy information.

Quantization Using K-Means and Self-Organizing Maps

According to an additional or another example implementation, in step S602 of FIG. 6, during training of the EMA module 200, d-dimensional training feature vectors are acquired, and the internal state-space model 320 is learned to follow a distribution of the training feature vectors, using at least one of K-means and self-organizing map algorithms with the training feature vectors as inputs.

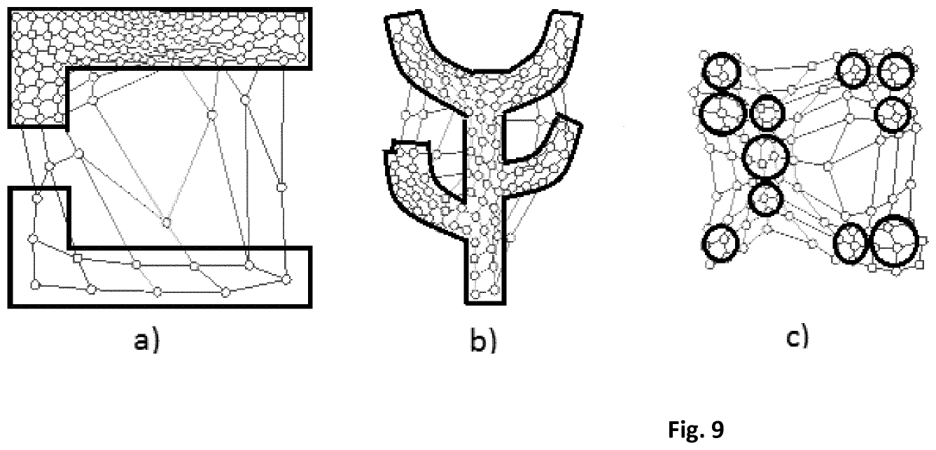

For quantization, two well-used algorithms are possible: K-means and the Self-Organizing Map (SOM) algorithm (described in citation [6]). Both algorithms achieve similar or the same functionality, which is splitting the input space into segments, while simultaneously fitting this segmentation to follow the distribution of a training data-set well. Both algorithms require the number of quanta (k) to be pre-defined before training, however, techniques exist for both algorithms to figure out an optimal number for k automatically. In the context of EMA, the quantization needs to create a fine-enough segmentation so that the state-abstraction later can be done precisely. This means that a pre-set high number of quanta (100-1000) should be enough without any need to fine tune k later. Other than the parameter k, no additional parameters are required by the training, which is entirely unsupervised. FIG. 9 illustrates SOMs a) to c) fitted on different distributions.

A downside of K-means and SOM algorithms is that since they try to represent the density of the data, they may underrepresent sections of the state-space, which in this use-case is undesired. The Bounding Sphere Quantization (BSQ) algorithm (described in citation [10]) could then be considered in this case. It uses similar or the same algorithmic framework as K-means, but uses a different goal function.

All-in-One State Modeling Using Sparse Autoencoders

According to an additional or another example implementation, in step S602 of FIG. 6, during training of the EMA module 200, n-dimensional training input vectors are acquired, and the internal state-space model 320 having dimension d is learned to follow a distribution of the training input vectors, using sparse autoencoders with the training input vectors as inputs.

Autoencoders can have a unique regularization mechanic where various degrees of sparseness can be enforced in the middle layer(s), so that it is encouraged that only a few neurons fire at any input vector. If the user enforces extreme sparseness, the middle neurons structure themselves and the whole encoding process so that each encompasses a certain finite region of the input space, very similar to explicit quantization algorithms. However, even very sparse autoencoders do not lose the ability to extract key features from the input space. This allows using sparse or k-sparse autoencoders (described in citation [7]) as both feature selectors and quantizers in a single step. This gives a more unified approach, with an end-to-end training structure.

Mapping as Simple or Neural Networks Based Labelling

According to an additional or another example implementation, in step S603 of FIG. 6, during training (and at runtime) of the EMA module 200, a labelling for mapping the output state bin to the selected internal state is formed based on training data created based at least on one of distribution and number of the output state bins.

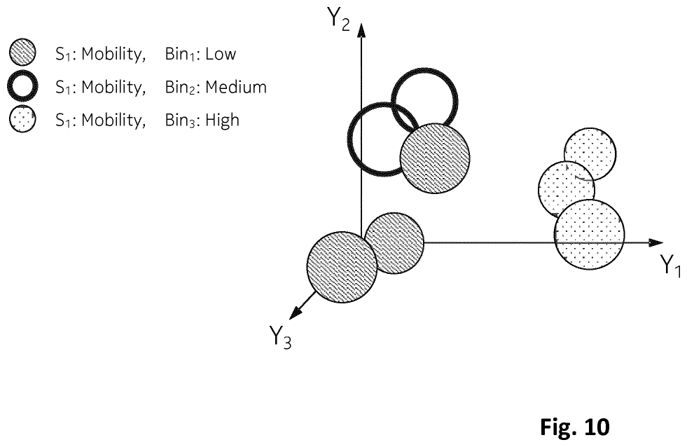

In particular, the mappers shown e.g. in FIG. 5 create and store a specific mapping for each output state, translating between the fine-grained internal representation and the output state bins. An illustration of a single mapping can be seen in FIG. 10. For this purpose, an individual mapper exists for each output state.

An example implementation of a mapper module is similar to the example in FIG. 10, i.e., the mapping is a labelling task, where for each output state a content is stored on the internal representation, creating a 1:1 mapping between internal states and output state bins. The formation of this labelling can be best done with training data (examples) supported as the combination of input vectors and required S-bin pairs. This training data can be manually created by the user, or automatically generated by the NOM module according to specific parameters, such as the distribution and number of bins.

LSTM (Long-Short Term Memory) (described in citation [8]) Neural Networks can also be used as labellers. These functions extend on the content labelling method by adding memory to the system. This can be useful for states that exhibit complex temporal behaviour, and can not necessarily be mapped in a 1:1 manner to unique internal states. The training of LSTMs can be realized in a similar or the same way as the simple labelling, generating or manufacturing labelled observations to function as training examples.

Subsetting Using Genetic Algorithms

Subsetting modules (e.g. the subsetters shown in FIG. 5) pick and choose the relevant output states for each connected CFs. The selection is strongly influenced by the specific CFs, requiring feedback from the CF in some form. For this reason, three possibilities are considered how this feature selection can be done during training or at runtime, also depicted in FIG. 5.

A first possibility is action feedback, in which the CF (CF₁ in FIG. 5) is not cooperating with the EMA module 200, requiring the subsetting module to monitor its output and deduce which output states influence its behavior. This requires a learning function in the subsetter (e.g. subsetter₁ for CF₁ as shown in FIG. 5). According to an example implementation, in step S604 of FIG. 6, during training (and at runtime) of the EMA module 200, different subsets are selected by monitoring outputs from the cognitive functions, and selecting the different subsets based on the monitored outputs.

A second possibility is direct feedback, in which the CF (CF₂ in FIG. 5) is cooperating with the EMA module 200, returning a numerical value that represents the goodness of the supported output states. This method also requires a learning module function in the subsetter (e.g. subsetter₂ for CF₂ as shown in FIG. 5), but can be realized in an easier way and will probably lead to a better performing selection than in the action feedback case. According to an example implementation, in step S604 of FIG. 6, during training (and at runtime) of the EMA module 200, different subsets are selected by receiving numerical values from the cognitive functions indicating assessments of the subsets, and selecting the different subsets based on the numerical values. Another even simpler case under direct feedback is when the CF specifically defines which outputs it needs.

A third possibility is no feedback, in which the CF (CF₃ in FIG. 5) does not need subsetting, either because it uses all the output states, or because it has an integral feature selection algorithm in place. This requires no additional action from the subsetting module (e.g. subsetter_{f} for CF_{f} as shown in FIG. 5), only to support all available output states to the CF.

The easier part of subsetting is in the case of direct feedback providing a numerical value of goodness. With this information, a search method such as a genetic algorithm (described in citation [9]) can be employed to figure out an optimal set of output states to be supported to each CF. However, the search requires multiple evaluations of candidate state sets, which requires an environment that detaches the search from real networks, such as a high level numerical modeling of the behaviour of the CF, or a lower level simulation of a network in which both the EMA and the CF are implemented.

Figuring out which information the CF most responds to by monitoring the actions it takes can also be done utilizing a genetic algorithm, however this solution might produce suboptimal results with regards to the CF's needs, as precise decisions can require information that is only used sparsely. The training of the subsetting module in this case can be done in a similar or the same way as in the case of direct feedback.

Offline and Online Training:

The applicable techniques for both modeling and abstraction require an amount of data with which to train the algorithms, yet this data is rarely available. For the eventual realization of the functional EMA module even without this necessary training data, the following process is proposed.

First, initial training via system simulations is performed. Data is generated from a system simulator in a large enough size and with enough detail to do an initial training.

Then, online semi-supervised training is performed. The partly trained EMA module is attached to a live system to learn from live data but without any actions being derived from its learnings. Instead, a human operator further trains it by e.g. adjusting the error calculated in the modeling step if the suggested abstract states are not those expected by the operator.

According to some embodiments, a uniform yet reconfigurable description of network states is enabled. Subsequent entities are able to reference a similar or the same state for the respective decisions. The states can also be used for reporting purposes e.g. to state how often the network was observed to be in a certain state at different times.

Further, once trained the EMA module can be used in multiple networks with minimal need for retraining.

According to an aspect, an environment modelling and abstraction, EMA, apparatus for enabling cognitive network management, CNM, in communication networks is provided. The EMA apparatus comprises means for, for a given time instant t, extracting features from an n-dimensional input vector X^{t} containing at least one of continuous valued environmental parameters, network configuration values and key performance indicator values, and forming a d-dimensional feature vector Y^{t} from the extracted features, means for quantizing the formed feature vector Y^{t} by selecting, for the extracted vector Y^{t}, a single quantum corresponding to an internal state of k internal states of an internal state-space model, means for mapping, for each dimension Sₘ of an m-dimensional output vector S^{t}, an output state bin of a number of output state bins present for dimension Sₘ to the selected internal state, and means for, for each cognitive function of f cognitive functions, selecting a subset out of the output vector S^{t}, each of the subsets having a dimension equal to or smaller than m and containing feature values required by the cognitive function, the f selected subsets being different in dimension from each other.

According to an example implementation, the means for extracting extracts the features from the input vector X^{t} using at least one of an independent component analysis and autoencoders.

According to an example implementation, the EMA apparatus further comprises means for acquiring d-dimensional training feature vectors, and means for learning the internal state-space model to follow a distribution of the training feature vectors, using at least one of K-means and self-organizing map algorithms with the training feature vectors as inputs.

According to another example implementation, the EMA apparatus further comprises means for acquiring n-dimensional training input vectors, and means for learning the internal state-space model having dimension d to follow a distribution of the training input vectors, using sparse autoencoders with the training input vectors as inputs.

According to an example implementation, the EMA apparatus further comprises means for forming a labelling for mapping the output state bin to the selected internal state based on training data created based at least on one of distribution and number of the output state bins.

According to an example implementation, the means for selecting selects the f different subsets by monitoring outputs from the cognitive functions, and by selecting the different subsets based on the monitored outputs.

According to an example implementation, the means for selecting selects the f different subsets by receiving numerical values from the cognitive functions indicating assessments of the subsets, and by selecting the different subsets based on the numerical values.

According to an example implementation, the EMA apparatus is implemented as a classifier configured to cluster the key performance indicator values or combinations of the key performance indicator values into the subsets that are logically distinguishable from each other.

According to an example implementation, the EMA apparatus comprises the control unit 70 shown in FIG. 7, and the above described means are implemented by the processing resources (processing circuitry) 71, memory resources (memory circuitry) 72 and interfaces (interface circuitry) 73.

It is to be understood that the above description is illustrative and is not to be construed as limiting the disclosure. Various modifications and applications may occur to those skilled in the art without departing from the true spirit and scope of the disclosure as defined by the appended claims.

1-17. (canceled)

18. An environment modelling and abstraction, EMA, apparatus for enabling cognitive network management, CNM, in communication networks, the EMA apparatus comprising at least one processor and at least one memory including computer program code, the at least one memory and the computer program code configured to, with the processor, cause the EMA apparatus at least to perform, for a given time instant t,
extracting features from an n-dimensional input vector X^{t} containing at least one of continuous valued environmental parameters, network configuration values and key performance indicator values, and forming a d-dimensional feature vector Y^{t} from the extracted features;
quantizing the formed feature vector Y^{t} by selecting, for the extracted vector Y^{t}, a single quantum corresponding to an internal state of k internal states of an internal state-space model;
mapping, for each dimension Sₘ of an m-dimensional output vector S^{t}, an output state bin of a number of output state bins present for dimension Sₘ to the selected internal state; and
for each cognitive function of f cognitive functions, selecting a subset out of the output vector S^{t}, each of the subsets having a dimension equal to or smaller than m and containing feature values required by the cognitive function, the f selected subsets being different in dimension from each other.

19. The apparatus of claim 18, the extracting comprising:
extracting the features from the input vector X^{t} using at least one of an independent component analysis and autoencoders.

20. The apparatus of claim 18, the memory further comprising computer program code configured to, with the processor, cause the apparatus to perform:
acquiring d-dimensional training feature vectors; and
learning the internal state-space model to follow a distribution of the training feature vectors, using at least one of K-means and self-organizing map algorithms with the training feature vectors as inputs.

21. The apparatus of claim 18, the memory further comprising computer program code configured to, with the processor, cause the apparatus to perform:
acquiring n-dimensional training input vectors; and
learning the internal state-space model having dimension d to follow a distribution of the training input vectors, using sparse autoencoders with the training input vectors as inputs.

22. The apparatus of claim 18, the memory further comprising computer program code configured to, with the processor, cause the apparatus to perform:
forming a labelling for mapping the output state bin to the selected internal state based on training data created based at least on one of distribution and number of the output state bins.

23. The apparatus of claim 18, the selecting f different subsets comprising:
monitoring outputs from the cognitive functions; and
selecting the different subsets based on the monitored outputs.

24. The apparatus of claim 18, the selecting f different subsets comprising:
receiving numerical values from the cognitive functions indicating assessments of the subsets; and
selecting the different subsets based on the numerical values.

25. The apparatus according to claim 18, wherein the EMA apparatus is implemented as a classifier configured to cluster the key performance indicator values or combinations of the key performance indicator values into the subsets that are logically distinguishable from each other.

26. An environment modelling and abstraction, EMA, method of enabling cognitive network management, CNM, in communication networks, the EMA method comprising, for a given time instant t,
extracting features from an n-dimensional input vector X^{t} containing at least one of continuous valued environmental parameters, network configuration values and key performance indicator values, and forming a d-dimensional feature vector Y^{t} from the extracted features;
quantizing the formed feature vector Y^{t} by selecting, for the extracted vector Y^{t}, a single quantum corresponding to an internal state of k internal states of an internal state-space model;
mapping, for each dimension Sₘ of an m-dimensional output vector S^{t}, an output state bin of a number of output state bins present for dimension Sₘ to the selected internal state; and
for each cognitive function of f cognitive functions, selecting a subset out of the output vector S^{t}, each of the subsets having a dimension equal to or smaller than m and containing feature values required by the cognitive function, the f selected subsets being different in dimension from each other.

27. The method of claim 26, the extracting comprising:
extracting the features from the input vector X^{t} using at least one of an independent component analysis and autoencoders.

28. The method of claim 26, further comprising:
acquiring d-dimensional training feature vectors; and
learning the internal state-space model to follow a distribution of the training feature vectors, using at least one of K-means and self-organizing map algorithms with the training feature vectors as inputs.

29. The method of claim 26, further comprising:
acquiring n-dimensional training input vectors; and
learning the internal state-space model having dimension d to follow a distribution of the training input vectors, using sparse autoencoders with the training input vectors as inputs.

30. The method of claim 26, further comprising:
forming a labelling for mapping the output state bin to the selected internal state based on training data created based at least on one of distribution and number of the output state bins.

31. The method of claim 26, the selecting f different subsets comprising:
monitoring outputs from the cognitive functions; and
selecting the different subsets based on the monitored outputs.

32. The method of claim 26, the selecting f different subsets comprising:
receiving numerical values from the cognitive functions indicating assessments of the subsets; and
selecting the different subsets based on the numerical values.

33. The method according to claim 26, wherein the EMA method is implemented as a classifier configured to cluster the key performance indicator values or combinations of the key performance indicator values into the subsets that are logically distinguishable from each other.

34. A non-transitory computer-readable medium storing a program comprising software code portions that cause a computer to perform, when the program is run on the computer:
for a given time instant t,
extracting features from an n-dimensional input vector X^{t} containing at least one of continuous valued environmental parameters, network configuration values and key performance indicator values, and forming a d-dimensional feature vector Y^{t} from the extracted features;
quantizing the formed feature vector Y^{t} by selecting, for the extracted vector Y^{t}, a single quantum corresponding to an internal state of k internal states of an internal state-space model;
mapping, for each dimension Sₘ of an m-dimensional output vector S^{t}, an output state bin of a number of output state bins present for dimension Sₘ to the selected internal state; and
for each cognitive function of f cognitive functions, selecting a subset out of the output vector S^{t}, each of the subsets having a dimension equal to or smaller than m and containing feature values required by the cognitive function, the f selected subsets being different in dimension from each other.
